(19) United States
(12) Patent Application Publication
(10) Pub. No.: US 2026/0327740 A1
(43) Pub. Date: Oct. 22, 2026

(54) Flexible Heat Input with Spatial Control and Rate Enhancement For Metal Ore Reduction

(71) Applicant: Alterna Materials LLC, Fort Collins, CO (US)

(72) Inventor: Herbert Lee Nigg, Fort Collins, CO (US)

(21) Appl. No.: 19/153,788

(22) PCT Filed: Dec. 27, 2023
(86) PCT No.: PCT/US2023/086082

§ 371 Date: Aug. 5, 2025

Related U.S. Application Data
(60) Provisional application No. 63/477,357, filed on Dec. 27, 2022.

(51) Int. Cl. C22B 4/08; C22B 4/04; C22B 5/12; C25B 1/23

(52) U.S. Cl. CPC C22B 4/08; C22B 4/04; C22B 5/12; C25B 1/23

(57) ABSTRACT

In embodiments, a system for reduction of metal ore is provided. The system has an entrance portion configured to receive the metal ore and a reductant, a reduction portion in fluid communication with the entrance portion configured to reduce the metal ore to a reduction stream. The reduction portion has a plurality of delivery tubes that extend into the reduction portion and are configured to receive at least a portion of the particles and gaseous species and deliver them into the reduction portion for ore reduction, a plurality of heat tubes configured to receive gaseous species for combustion and a second heat source proximate the heat tubes to further heat the particles and gaseous species inside the reduction portion.

### REFERENCE TO RELATED APPLICATION

This application is a United States National Stage Application filed under 35 U.S.C. § 371 of International Patent Application No. PCT/US2023/086082 entitled Flexible Heat Input with Spatial Control and Rate Enhancement For Metal Ore Reduction filed on Dec. 27, 2023, which itself claims the benefit of U.S. Provisional Serial No. 63/477,357 entitled Metal Ore Reduction Flexible Heat Input with Spatial Control and Rate Enhancement filed on Dec. 27, 2022, the entire contents of which are incorporated by reference herein for all purposes.

### TECHNICAL FIELD

The present disclosure relates generally to systems, devices and methods for metal ore reduction. More specifically, the present disclosure describes systems and methods for effectively delivering heat to metal ore as a process feature in reducing the metal ore by reactions with hydrogen, syngas or hydrocarbons.

### BACKGROUND

The overwhelming majority of the world's metal ores are reduced (i.e., oxygen, sulfur or carbon are stripped from the metal ore) by means of processes that are difficult to optimize, resulting in a large thermal (i.e., heat) loss and a high amount of greenhouse gas generation. In iron oxide ore, for example, the typical reduction process uses coke in a high-temperature batch method that is very inefficient, generating large heat losses and carbon dioxide emissions.

There are hydrogen, syngas or hydrocarbon reductant-based methods to continuously reduce iron oxide ore (powder or particles) that are more amenable to optimization that decrease heat loss and greenhouse gas emission. In this regard, reductant and ore are mixed in a vessel heated typically by combustion. Combustion may be by hydrocarbons such as natural gas in air or oxygen, or by hydrogen in air or oxygen. Combustion may be by complete oxidation or partial oxidation. Typically, combustion is initiated at a single location or section of the vessel such as the top or bottom.

Combustion within the ore reduction section of the vessel exposes ore and reductant to combustion products. These products, otherwise known as exhaust, include carbon dioxide and water vapor which can become mixed with ore and reductant. Since the ore reduction reaction product species are the same, this elevated concentration can suppress or reverse the ore reduction reaction. If air is used for combustion, the nitrogen will become distributed throughout the vessel and absorb heat away from ore reduction. This requires a higher heat input to achieve reduction. Combustion exhaust, alongside ore and reductant, also reduces the overall production capacity for a given vessel since the combined gaseous content disrupts fluid dynamic profiles desired for effective ore-reductant contact. To maintain such profiles, a lower ore-reductant feed rate is required, resulting in a lower production rate. Additionally, typical configurations for delivering heat into the vessel result in the heat flux becoming spread out, causing it to diffuse, homogenously and in contact with surfaces that transfer heat out of the vessel. This results in a higher required heat input to ensure heat flux is occurring where needed in order to achieve temperature required for ore reduction. Any aspect of a process that requires higher heat input to achieve the same production specification and rate, can also increase the generation rate of greenhouse gases should hydrocarbons be used for energy input by any source or method.

Consequently, what is needed is a system and method for effectively delivering heat and reductant to metal ore that alleviates the above-recited drawbacks, specifically as it relates to heat loss and greenhouse gas generation.

### SUMMARY

The present disclosure relates generally to systems, devices and methods for metal ore reduction. More specifically, the present disclosure describes systems and methods for effectively delivering heat and reductant to metal ore as a process feature in reducing the metal ore by reactions with hydrogen, syngas or hydrocarbons.

In embodiments, a system for reduction of metal ore is provided. The system comprises an entrance portion configured to receive the metal ore and a reductant, wherein the metal ore and a reductant is heated with a first heat source; a reduction portion in fluid communication with the entrance portion, wherein the reduction portion is configured to receive the metal ore and the reductant, wherein the reduction portion is configured to reduce the metal ore to a reduction stream, wherein the reduction stream comprises particles and a gaseous species, and wherein the reduction portion comprises: a plurality of delivery tubes that extend into the reduction portion and are configured to receive at least a portion of the particles and gaseous species and deliver them into the reduction portion for ore reduction; a plurality of heat tubes configured to receive gaseous species for combustion; a second heat source proximate the heat tubes, wherein the second heat source is configured to further heat the particles and gaseous species inside the reduction portion by application of a combustion stream inside the heat tube and a reductant stream outside the heat tube; and an exit portion coupled to the reduction portion, wherein the exit portion is configured to release the reduced species and the solid and gaseous species.

In embodiments, a method for reduction of metal ore is provided. The method comprises receiving the metal ore and a reductant at an entrance, heating metal ore and a reductant with a first heat source, receiving the metal ore and the reductant at a reduction portion, reducing the metal ore to a reduction stream, wherein the reduction stream comprises particles and a gaseous species, receiving at least a portion of the particles and gaseous species and deliver them into the reduction portion for ore reduction using delivery tubes, receiving he gaseous species using a plurality of heat tubes for combustion, heating, using a second heat source proximate the heat tubes, the particles and gaseous species inside the reduction portion by application of a combustion stream inside the heat tube and a reductant stream outside the heat tube, releasing the reduced species and the solid and gaseous species at an exit portion.

In embodiments, a module reduction device that couples with a reduction system is provided. The reduction device comprises a plurality of delivery tubes that extend into the reduction portion and are configured to receive at least a portion of particles and gaseous species from metal ore duction, a plurality of heat tubes configured to receive a gaseous species for combustion, a second heat source proximate the heat tubes, wherein the second heat source is configured to further heat the particles and gaseous species inside the reduction portion by application of a combustion stream inside the heat tube and a reductant stream outside the heat tube.

In embodiments, advantageously, the systems and methods described herein according to one aspect of the instant disclosure, there is provided a device and method that performs at least some, and preferably all, of the functions required to effectively perform metal ore reduction using hydrogen, CO, syngas or hydrocarbons. According to another aspect of the instant disclosure, there is a device and method that performs at least some, and preferably all, of the functions required to ensure the effective generation and transport of heat when and where needed to rapidly, effectively and efficiently reduce metal ores. According to another aspect of the instant disclosure, there is a device and method that performs at least some, and preferably all, of the functions required to ensure the effective generation and transport of heat by any combustible species, heating source or method to rapidly, effectively and efficiently reduce metal ores. According to another aspect of the instant disclosure, there is a device and method that performs at least some, and preferably all, of the functions required to ensure a high ratio of reductant to ore when and where needed to rapidly, effectively and efficiently reduce metal ores. According to another aspect of the instant disclosure, there is a device and method that performs at least some, and preferably all, of the functions required to lower the energy quantity required to reduce metal ore, thereby, increasing the energy-efficiency for the process.

In embodiments, advantageously, the systems and methods described herein reduces the areal footprint of the overall facility.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF FIGURES

Aspects of the present disclosure are illustrated by way of example and are not limited by the accompanying figures for which like references indicate like elements.

FIG. 1 shows a series of vertical sectional views of an exemplary integrated reactors system with flow directions for materials using devices and methods for managing heat input in accordance with embodiments;

FIG. 2 shows another series of vertical sectional views of an exemplary integrated reactors system with flow directions for materials using devices and methods for managing reductant generation in accordance with embodiments;

FIG. 3 shows another series of vertical sectional views of an exemplary integrated reactors system with flow directions for materials using devices and methods for managing heat input in accordance with embodiments;

FIG. 4 shows another series of vertical sectional views of an exemplary integrated reactors system with flow directions for materials using devices and methods for managing reductant generation in accordance with embodiments;

FIG. 5 is a series of horizontal cross-sections of exemplary plate types in an integrated reactor system for the relative introduction of materials for ore reduction and heat input in accordance with embodiments; and

FIG. 6 is a step-wise flow chart for a method for delivering heat to metal ore as a process feature in reducing the metal ore by reactions with hydrogen, syngas or hydrocarbons.

### DETAILED DESCRIPTION

Exemplary embodiments are discussed below with reference to the Figures.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub combinations of several further features disclosed above. In addition, the logic flows depicted in the accompanying figures and/or described herein do not necessarily require the particular order shown, or sequential order, to achieve desirable results. Other implementations may be within the scope of the following claims.

The described embodiments are to be considered in all respects only as illustrative and not restrictive. The scope is, therefore, indicated by the appended claims rather than by the foregoing description. All changes that come within the meaning and range of equivalency of the claims are to be embraced within their scope.

### Exemplary Materials for Reduction

Various metal ores types may be reduced in exemplary reactor systems. For instance, metal ores may include, but are not limited to, carbides, oxides and sulfides of Al, W, Ti, Fe, Cu, Cr, Co, Zn, Mn, Sn, V, Ni, Sm, Mg, Li, Sc, Y, U, Th and lanthanides. Exemplary systems may be particularly suited for iron oxide ores. In some embodiments, metal ores provided to reactor systems may comprise Fe2O3 and/or Fe3O4.

Exemplary metal ores provided to exemplary reactor systems may be in powder form. Particles comprising exemplary powders provided to reactors may have a nominal length or diameter between 10-250 microns. Exemplary reduced metal ore or partially reduced metal ore may be a powder with nominal length or diameter ranging from 5 -245 microns.

Various gases may be provided to exemplary reactor systems and are typically reductants. For instance, exemplary gaseous species may comprise reductants such as hydrogen (H2), carbon monoxide (CO) and methane (CH4). Other exemplary gases, for combustion, may include hydrogen (H2), carbon monoxide (CO), methane (CH4), natural gas, hydrocarbons, alcohols and ketones as well as air and oxygen (O2).

Outlet streams provided by exemplary reactor systems may comprise solids and gaseous streams, which may comprise reduction products, unreacted reductants, unreacted solids, and/or unreacted combustibles and combustion products. Exemplary unreacted reductant species may comprise hydrogen (H2), carbon monoxide (CO) and methane (CH4). Exemplary reduction products may comprise iron (Fe), FeO, CO2, H2O, and combinations thereof. Exemplary unreacted solids may comprise Fe2O3 and/or Fe3O4. Exemplary combustion products may comprise CO2, H2O, nitrogen (N2), NOx. Exemplary unreacted combustibles or combustion required species may comprise H2, CO, O2, CH4, other hydrocarbons, alcohols, ketones and combinations thereof.

Various catalysts may be used in or on the combustion tubes, and exemplary catalysts may be particularly suited for steam-methane reforming, carbon dioxide-methane reforming, other reforming methods, species decomposition, or combinations thereof or for catalytic combustion. Exemplary catalysts may comprise Ni, Fe, Cu, Cr, Co, Pt, Pd, Rh, Re, Ti, Os, La, Al, Si, a single element or combination of elements, reduced or oxide. In some embodiments, the catalyst may be bulk material, mixed with or dispersed upon alumina, silica, titania or zirconia.

Various materials may be used in or on the heat tubes, and exemplary materials may be particularly suited for the electrolysis of gaseous species such as CO2 and H2O to form CO and H2. Exemplary materials for electrodes and electrolytes may comprise yttria stabilized zirconia (with or without Ni or Sc), lanthanum strontium manganite yttria stabilized zirconia, bismuth oxide, lead oxide, Ni-cermets, niobates (with or without Mn, Ti or Fe), molybdenum sulfide, cerium compounds and alloys, Ni compounds and alloys, rare earth doped Ce, lanthanum-based compounds and may contain carbon, singular species or compounds or combinations of species or compounds, or combinations.

Heat tubes, or other tubes associated with heat generation and transfer, may be formed from alumina, silica, titania, silicon carbide, aluminum nitride, titanium, tungsten, stainless steel, copper, aluminum, nickel, Inconel, Hastelloy or various combinations or alloys.

### Exemplary Reactor Systems

Generally, exemplary reactor systems comprise entrance portions, reduction portions, heating components, and exit portions. Various operating conditions and exemplary configurations are discussed below.

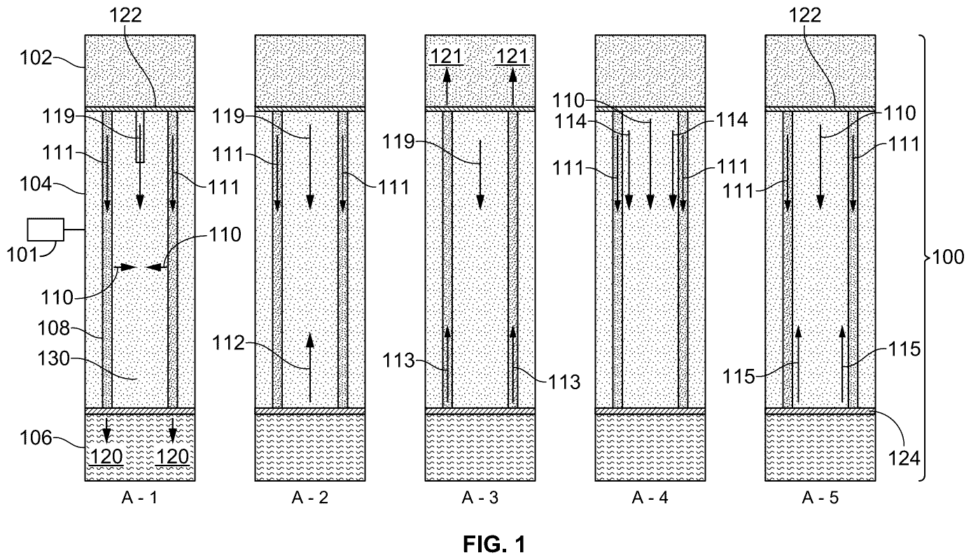

FIG. 1 shows exemplary configurations A-1, A-2, A-3, A-4 and A-5 of a reactor system 100. Reactor system 100 comprises entrance portion 102, reduction portion 104 and exit portion 106. Entrance portion 102 receives solids, which may be particles, powders, and the like, as well as gaseous species. As discussed above, exemplary solids species may comprise Fe2O3 and Fe3O4. Exemplary gaseous species may comprise reductants such as H2, CO and CH4 which enters reduction portion 104, which is in fluid communication with the entrance portion. A heat source 101, which may be external or internal, and may be referred to as first heat source or primary heat source is configured to heat the matter in in the reduction portion 104, which may be waste heat from streams exiting the reduction portion.

Reduction portion 104 comprises a plurality of heat tubes or pipes 108 configured to contain combustion or other heating sources and mechanisms described further herein. Heat flux 119 represents heat transferred into reduction portion 104. Arrow 110 represents the introduction of particles and reductant gas into reduction portion 104 emanating through a tube from plate 122. The heat flux direction may be isotropic or anisotropic. Flow directions 120 and 121 show the flow direction of combustion species or exhaust given the original flow direction for combustion. These exit flow streams (or second flow stream) are not mixed with the other (or first) flow streams outside of heat tubes 108 within reduction portion 104.

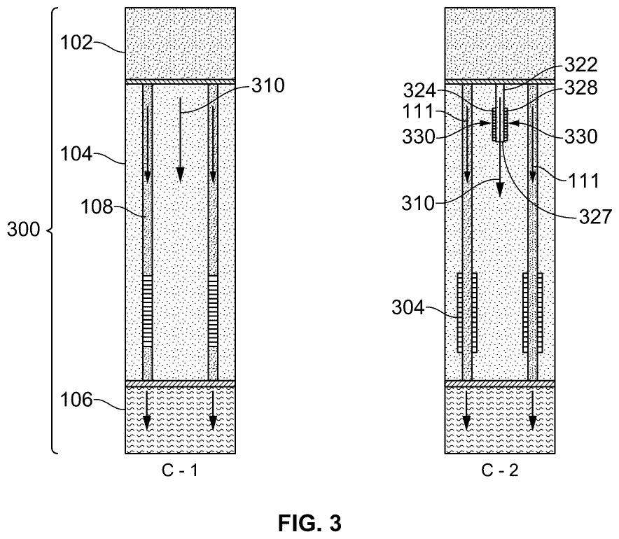

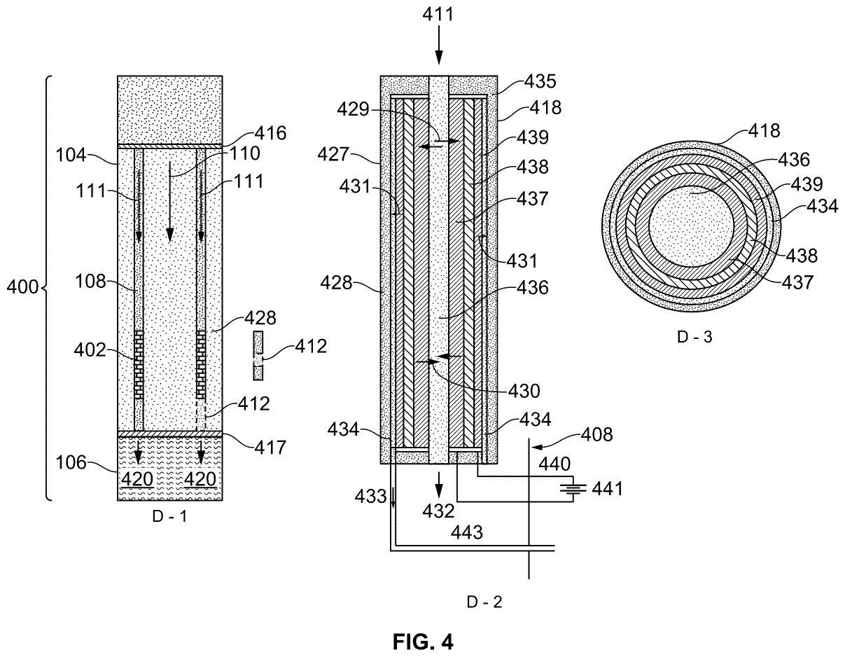

Reactor system 100 may also include a plurality of ore and reductant delivery tubes emanating from top plate 122 or heat tubes 108, configured to accommodate a variety of heating and reductant generating mechanisms and methods to be discussed with greater detail in relation to FIGS. 3 and 4.

The interior 130 of reduction portion 104, outside heat tubes 108, receives solids, which may be particles, powders, and the like, as well as gaseous species. Exemplary sizes for solids are provided in greater detail above. As discussed above, exemplary solids species may comprise Fe2O3 and Fe3O4. As discussed above, exemplary gaseous species may comprise reductants such as H2, CO and CH4. As discussed above, exemplary gaseous species may comprise combustion reactants such as H2, CO, CH4 and O2 or air. In some examples, exemplary gaseous species for combustion may be provided to facilitate partial oxidation which provides exemplary gaseous reductant species.

Reduction portion 104, inside heat tubes 108, receives gaseous species for combustion such as H2, CO, CH4 and O2 or air. A second or other heat source may be applied to the heat tube, examples of the second or other heat sources or mechanisms that may be used are electrical-based power which provide resistive heating or inductive heating or a combination thereof. In some embodiments, resistive, microwave, laser-based, plasma-forming or inductive heating may be applied to features attached outside of heat tubes 108. In some embodiments, there may be combinations of combustion, resistive, microwave, laser-based, plasma-forming and inductive heating applied to any single heat tube 108 or distributed amongst heat tubes 108.

In some embodiments, exemplary solids and gaseous species may be provided to the reduction portion 104 at a temperature between 300 °C and 1000 °C, but can be as low as room temperature. In some embodiments, exemplary solids and gaseous species may be provided to the reduction portion 104 at a pressure between 15 psia (or just above local ambient pressure) and 150 psia. These parameters also apply to heat tubes 108.

Heat is provided in the reduction portion 104, via heat tubes 108 or external to heat tubes 108 by partial oxidation or a combination, to provide energy required for ore reduction. As a result, solid species may react with gaseous species while traveling through reduction portion 104. The result is a mix of solid and gaseous species which exit reduction section 104. Exemplary species may comprise unreacted reductants such as H2, CO, CH4, reduction products such as Fe, FeO, CO2 and H2O, unreacted solids such as Fe2O3 and Fe3O4 and combustion products such as CO2 and H2O. Combustion or partial oxidation might also include nitrogen if air is used, NOx if nitrogen is present and oxygen, which is often provided in excess for combustion.

In some embodiments, exemplary solids and gaseous species may reach temperatures of 1450 °C or higher within reduction section 104. In some embodiments, exemplary solids and gaseous species may be at a pressure between 15 psia (or just above local ambient pressure) and 150 psia within reduction section 104. In some embodiments, exemplary heat tubes 108 may reach temperatures as high as 1950 °C within reduction section 104. In some embodiments, exemplary heat tubes 108 may be at a pressure between 15 psia (or just above local ambient pressure) and 150 psia.

In some embodiments, reduction portion 104 is generally cylindrical. In those embodiments, reduction portion 104 may have an inner diameter that is generally constant along the flow direction of the particles (that is, the length of the reduction portion 104).

In some embodiments, heat tube 108 is generally cylindrical. In those implementations, heat tube 108 may have an outer diameter that is generally constant along the flow direction of the particles (that is, the length of the reduction portion 104). Heat tubes 108 have an outer diameter which is ⅛ the inner diameter of reduction portion 104 or less. Heat tubes 108 have an inner diameter that is ½ the outer diameter or more.

In some embodiments, heat tube 108 may contain external features that enhance heat transfer from the heat tubes 108, providing an additional heat source or generating additional reductant into reduction portion 104. Exemplary external features may include fins, foams, foils, beads, pellets and radiative reflectors. In those embodiments, heat tube 108 may have an outer diameter that varies along the flow direction of the particles (that is, the length of the reduction portion 104). Radiative heat reflecting features may be located around up to ¾ of the outer circumference of any heat tube 108 such that reflection or emission is directed towards sections of reduction portion 104 containing higher densities of ore and reductant.

In some embodiments, heat tube 108 may contain internal features which enhances heat transfer from the heat tubes 108 or provides an additional heat source into reduction portion 104 or generates additional reductant into reduction portion 104 or generates additional reductant which is transported out of reduction portion 104 for use elsewhere in the reactor system 100. Exemplary internal features may include fins, foams, foils, beads, pellets and radiative reflectors. In those implementations, heat tube 108 may have an inner or outer diameter that varies along the flow direction of the particles (i.e., the length of the reduction portion 104).

Exemplary configurations of heat tubes 108 include between three to twenty-five tubes arrayed in various patterns and are connected between and through upper plate 122 and/or lower plates 124. In one instance, all the heat tubes 108 are located in the outer ⅓ of the inside diameter of reduction portion 104. In another instance, all the heat tubes 108 are located in the inner ⅔ of the inside diameter of reduction portion 104. In other embodiments, heat tubes 108 are located interspersed among and in close proximity to streams 110, 112, 114 and 115 to facilitate heat transfer to such streams.

Streams 112, 114 and 115 represent reducing gas or combustion emanating from the bottom plate, 124 or the top plate, 122. In some embodiments of 114, where this is a reducing gas stream, particles might also be present.

Heat tubes 108 are patterned in proximity, in particular to streams that contain ore, reductant or ore and reductant, to provide the shortest distance from the heat flux source to such streams to facilitate heat transfer. Heat tubes 108 are also patterned in proximity, in particular to streams that contain ore, reductant or ore and reductant, to maximize heat tube 108 outside surface area in a line-of-sight to such streams. Each configuration maximizes the heat flux that can be absorbed or captured by ore and reductant species.

Exemplary configurations of heat tubes 108 coupled to entrance portion 102 or exit portion 106 apply heat exchanging devices to recover heat from combustion exhaust for pre-heating ore, reductant and combustion reactants. Pre-heating of ore and reductant may be sufficient to initiate ore reduction reactions. Pre-heating of combustion reactants may be up to autoignition temperature. Heat exchangers may be shell and tube or other typical designs.

In some embodiments, the top plate 122 and bottom plate 124 and the heat tube 108 assembly are modular, allowing for simple and rapid replacement for maintenance purposes, modification for accommodating different ore and reductant types for scale-up.

Still with reference to FIG. 1, ore and reductant stream 110 and the combustion stream 111, shown within heat tubes 108 (in A-1), are applied along with a partial oxidation stream 114 outside of heat tubes 108. In all examples, all streams flow in the downward direction. In configurations A-2 through A-5, the reductant stream 110 emanates from the top plate 122 and is outside of heat tube 108.

In configurations A-2, A-3 and A-5 streams are shown which may emanate from the bottom upward. 112 is a reducing gas or combustion stream. Combustion may be complete or partial oxidation. 113 is a combustion stream emanating upward from within pipes 108. 115 is a reducing gas or combustion stream. Combustion may be complete or partial oxidation.

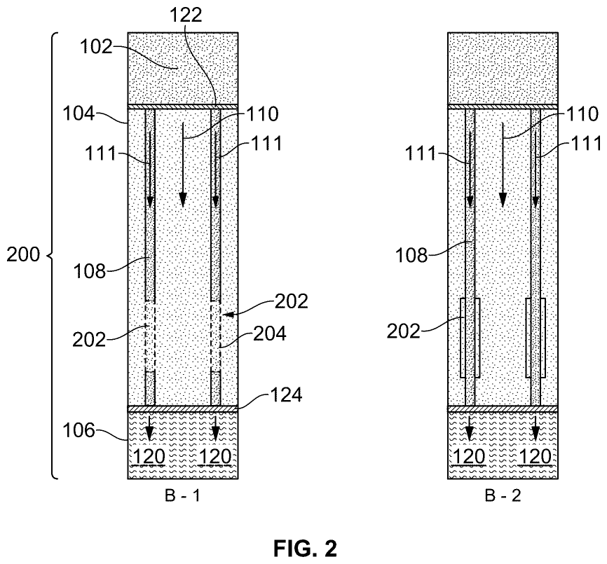

With reference now to FIG. 2, another series of vertical sectional views of an exemplary integrated reactors system with flow directions for materials using devices and methods for managing reductant generation is shown at reference numeral 200.

Exemplary configurations in FIG. 2 show the use of catalysts 202 with two exemplary configurations shown in B-1 and B-2 for reactor system 200. Configuration B-1 shows the catalyst 202 located inside the heat tubes 108, whereas configuration B-2 shows the catalyst 202 outside the heat tubes 108. When the catalysts are inside the heat tubes, pores 204 may be provided to allow for ingress and egress of gasses, in some embodiments. Pores 204 are where the products of the catalyst promoted reaction inside can pass through heat tubes 108 and enter the reduction section 104 where reductants can participate in ore reduction reactions. Catalysts may be coated on or dispersed upon walls, foams, fins, foils, beads, pellets, powders or particles or may exist as bulk beads, pellets, powders or particles.

For catalysts inside heat tubes 108, combinations of CO2, H2O, in combustion exhaust, and unreacted CH4 are converted to H2 and CO by steam-methane or carbon-dioxide-methane reforming. Combinations of CO, from inefficient combustion, and H2O are converted to H2 and CO2 by water-gas shifting. Water-gas shifting also adds heat into the reduction section 104 since the reaction is exothermic. Where there are no pores in the heat tube, the reductant transports inside the heat tubes 108 and exits above plate 122 or below plate 124, where it may be used elsewhere in reactor system 200. Where there are pores in the heat tube, reductant transports into reduction portion 104, fully or partially. Where partially transported, the remainder transports above plate 122 or below plate 124.

For catalysts outside heat tubes 108, combinations of CO2 and H2O, from ore reduction reactions, and unreacted CH4 are converted to H2 and CO by steam-methane or carbon-dioxide-methane reforming. Combinations of CO and H2O are also converted to H2 and CO2 by water-gas shifting. Water-gas shifting also adds heat into the reduction section 104 since the reaction is exothermic.

In other embodiments inside heat tubes 108, combustion catalysts are deployed to complete the combustion of unreacted combustible species such as H2 or CH4 and O2. This ensures efficient combustion of all combustibles and can be located where and when additional heat is needed in reduction portion 104. In other embodiments, the location, type and amount of catalysts can be anywhere along a heat tube 108, inside or outside, or varied amongst heat tubes 108.

Referring now to FIG. 3 another series of vertical sectional views of an exemplary integrated reactors system with flow directions for materials using devices and methods for managing heat input is shown at reference numeral 300 in configurations C-1 and C-2. In these embodiments, electrical power-based heating elements 302 are located inside or outside the heat tubes 108. These elements may be resistive, inductive, laser-based, plasma-forming or microwave heating or a combination, inside heat tubes 108 as shown in C-1 (elements 302), or outside heat tubes 108, as shown in C-2 (elements 304). Generated heat is available within reduction section 104 for ore reduction. Generated heat is also available inside heat tubes 108.

In the instance of resistive heating on the outside of or within heat tubes 108, heat is generated by electrical current in a coil or rod where it transfers into reduction section 104, outside of heat tubes 108, by radiation or by conductive contact with gaseous species. Outside heat tubes 108 this is direct, whereas, inside heat tubes 108 this must first be transferred through the heat tube 108 wall.

In the instance of induction heating on the outside of or within heat tubes 108, the operation of induction coils is primarily done using parameters identified to electromagnetically induce heating of ore or reduced metal particles inside reduction portion 104 which is outside heat tubes 108. Secondarily, the parameters can be selected to electromagnetically induce heating of the heat tube 108, from which heat is then transferred into reduction section 104 by radiation or by conductive contact with gaseous species.

In the instance of microwave heating on the outside of or within heat tubes 108, the operation of a magnetron is done such that microwaves are generated that result primarily in the heating of ore and reductant, within reduction portion 104 and outside heat tubes 108. Operation might also be done to heat other species outside heat tubes 108 which transfer heat to ore and reductant by contact. Operation might also be done to heat other species inside heat tubes 108 which transfer heat to ore and reductant, inside reduction portion 104 but outside heat tubes 108, by radiation and by gaseous species contact, after first transferring heat to or through heat tube 108 walls.

In another embodiments, a delivery tube or pipe 322 may be provided toward a top of the reduction portion 104. Delivery tube 322 can surround any port or nozzle that delivers ore, reductant or ore and reductant, for example, up to ⅓ of the length or height of reduction portion 104, in any direction up or down, and delivers heat to such species by attachment 327 for resistive, inductive, laser-based, plasma-forming or microwave heating. It can surround, none, one or more of such ports or nozzles. The heat flux can be in the direction of 329, to the internal stream components which include ore, reductant or ore and reductant. The heat flux can be in the direction of 310, the reduction portion of 104 outside of heat tubes 108. Operation of resistive, inductive. Laser-based, plasma forming or microwave heating are as described for heat tubes 108.

In other embodiments, the location and type of heating mechanism and the amount of heat can be anywhere along a singular heat tube 108 or delivery tube 322, inside or outside, or varied amongst heat tubes 108 and delivery tubes 322.

With reference now to FIG. 4, another series of vertical sectional views of an exemplary integrated reactors system with flow directions for materials using devices and methods for managing reductant generation is shown at 400.

In this embodiment, electrolytic cells 427 are located inside heat tube 108, although they can also be located outside but attached to heat tubes 108. The high-temperature electrolytic cells create reductants such as H2 and CO from H2O and CO2. H2O and CO2 are present both in combustion exhaust and in ore reduction products. Additionally, O2 is created which can be deployed for efficient combustion or partial oxidation.

Electrical power is used for the electrochemical reactions but their deployment in the reduction portion 104 operating temperature ranging from 300 to 1000 °C can effectively reduce the power requirement for electrolysis by at least 5%.

In the exemplary configuration shown, inside heat tube 108, electrolytic cell 402 of view D-1 is highlighted (using arrows 428) in view D-2 and shown in top view D-3. Flow direction 411 comprises combustion exhaust which enters internal channel 436. Cap 435 (top and bottom of cell) provides structure to the cell which separates components electrically and prevents gaseous bypass of internal features. A mesh, sieve of filter feature is applied at the entrance and exit of 436 to prevent particles from entering the cell.

Gases in 411 enter porous cathode 437 as stream 429. Power is applied across cathode 437 and anode 439 by a power source 441 using circuit 440. Power is likely located outside of the reduction section 408 wall.

Oxygen anions from dissociated H2O and CO2 transport through electrolyte layer 438 to porous anode 439 and recombine with electrons released in the dissociation of H2O and CO2 that transported to anode 439 through circuit 440. In this process, H2 and CO formed in the cathode, exit the cathode as stream 430 into channel 436 and then exit the electrolytic cell in flow direction 432 but are still inside heat tube 108. Also in this process, O2 formed in the anode, exits the anode as stream 431 into channel 439 and then enters outlet 434 and then exits the electrolytic cell in flow direction 433 inside pipe or tube 443. Oxygen exits the reduction section 408 through 443 which penetrates the wall of 408. Oxygen can be used for combustion elsewhere in reactor system 1.

Stream 432 comprises electrolytic cell generated reductants and unreacted combustion exhaust and may exit into portion 106 as stream 420 to be used elsewhere in reactor system 1. Stream 432 might also exit heat tube 108 at pores, ports and openings, 442, and directly enter reduction section 108 where reductants participate in ore reduction. A mesh, sieve of filter feature is applied on 442 to prevent particles from entering the cell. The electrolytic cell stack 402, is shown as cylindrical but can be many shapes including rectangular, square or trapezoidal stacks.

A catalytic bed or reactor located in an interior or on the exterior of the heat tubes to generate additional reductants using gaseous species and reduction products is provided as well.

Particles may be undesired in the electrolysis cell or stack and, therefore, meshes, membranes and sieves may be applied to prevent particle penetration into the cell or stack.

In other embodiments, the location, shape and type of electrolytic cell can be anywhere along a singular heat tube 108, inside or outside, or varied amongst heat tubes 108.

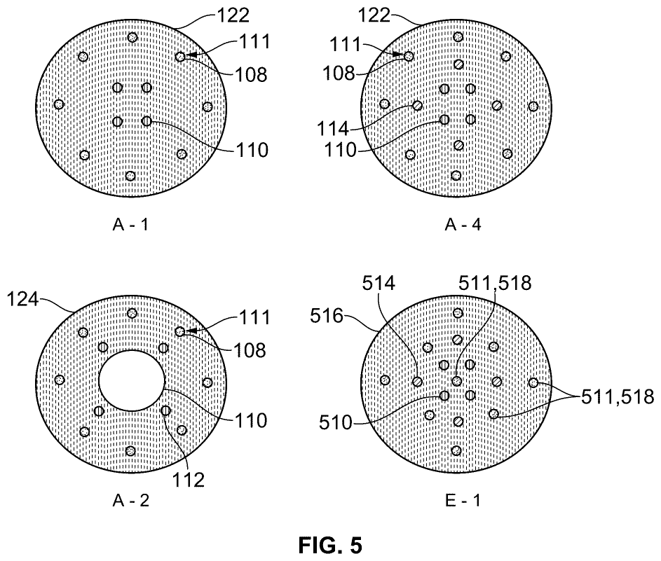

FIG. 5 is a series of horizontal cross-sections of exemplary plate types in an integrated reactor system for the relative introduction of materials for ore reduction and heat input showing exemplary configurations of plates 122 and 124, namely, configurations, A-1, A-2, A-4 and additional configuration E-1. The additional arrangement is plate 516 (configuration E-1).

Plates 122 at the top of reduction section 104, which match configurations A-1 and A-4, show relative locations for the ore and reductant stream 110, the combustion stream 111, within heat tubes 108 and the partial oxidation stream 114. In all examples, all streams flow in the downward direction.

Plate 516, at the same position as plate 122, shows relative locations for the ore and reductant stream, 510, the combustion stream 511, within heat tubes 518 and the partial oxidation stream 514. Shown here are the numerous locations for heat tubes 518 in two radial planes, intermingled with other streams plus a heat tube in the center. Many configurations are contemplated.

Plate 124 in A-2, at the bottom of reduction portion 104, shows relative locations for the reduced metal stream exit 110 (modified) flowing in the downward direction, the combustion stream flowing in the downward direction 111, within heat tubes 108, and the reductant stream 112, flowing in the upward direction. Shown here is the large opening for reduced metal exit, labeled as 110 since it originally initiated as ore stream 110, from the top. However, this stream may also comprise gaseous species such as unreacted reductant and reduction reaction products along with various oxidation states of ore that did not complete reduction.

In sum, the plates comprise a first plurality of channels that supply the particles and gaseous species into the heat tube for ore reduction, a second plurality of channels that supply gaseous species into the heat tube for combustion, and a third plurality of channels that supply gaseous species outside of the heat tube for combustion in the form of partial oxidation and a plurality of channels that supply the particles and gaseous species outside of the heat tube for ore reduction.

Exemplary methods of operating a reactor may be applied to exemplary reactor configurations shown in FIGS. 1-5 and discussed above. Reference below to certain portions of certain reactors is made for convenience only and without limitation. Broadly, exemplary reactors comprise a reduction portion, which may also include heating, an entrance portion, tubes for heating and an exit portion.

Solids and gaseous species enter or are delivered into the reduction portion 104 outside 108 through ports, nozzles or tubes from the top 122 by gravity, a pressure differential or flow driving mechanism (in the case of gases) or both. For solids, mechanical devices such as screw augers might also assist or provide the delivery mechanism to the inlet or boundary of 104. For solids, they may also be entrained in a gas flow and be transported in the direction of flow. Gaseous species are for reduction but may also be for combustion, complete or preferred partial, to provide heat. Gaseous species might also be delivered into the reduction portion 104 outside 108 from the bottom 124 via a pressure differential or flow driving mechanism. Pressure differentials and flow directions are accomplished by pumping, blowing, compression and pressure-regulating or flow controlling devices.

Gaseous species enter or are delivered into the reduction portion 104 inside 108 through openings, ports or nozzles from the top 122 or from the bottom 124 for combustion, preferred complete or partial. Methods to accomplish pressure differentials and flow directions are accomplished by pumping, blowing, compression and pressure-regulating or flow controlling devices.

Heat, based on combustion, is supplied for ore reduction (also referred to as metallization). Where all heat is supplied from within tubes 108, heat is transferred to the tube wall which becomes hot and also radiates heat to ore and reducing gas within 104. Gas or ore which contacts the outside of tubes will receive heat by conduction and gas which contacts the tubes will also transport that heat to ore and other reducing gas, not in contact with the outside of tubes, by convection and contact/conduction.

Any heat for ore reduction (or metallization), based on combustion, supplied from outside of tubes 108 is transferred by radiation, notably, surrounding the flame zone, to ore and reducing gas. Heat is also transferred by conduction where ore and reducing gas contact the combustion flame and combustion exhaust directly. Heat is also transported by convection of combustion exhaust which contacts reducing gas and ore, transferring heat by conduction. Heat is also transported by convection of reducing gas, which contacts the combustion flame and combustion exhaust and transfers heat by contact/conduction to ore and other reducing gases not in proximity to the combustion flame or combustion exhaust.

Heat is also generated and transferred by other means, for the purpose of ore reduction using a gaseous reductant, which includes the primary mechanisms:
Resistive heating: Radiation and conduction (direct contact of ore and gas at resistively heated surface);
Inductive heating: Electromagnetic field coupling with a material to cause internal motion within that material, generating heat;
Microwave: Microwave spectral coupling with a material to cause internal vibrations within that material, generating heat;
Lasers: Absorption of the laser wavelength by a material to cause vibrations within that material, generating heat;
Plasma: Application of an electric current across electrodes which causes the generate of a gas plasma, generating heat.

In addition to heat generated directly within a material using noted mechanisms, heat is transferred by radiation and conduction to other materials that were not directly impacted by such mechanisms. In some instances, there may be examples of ore becoming reduced or metallized without the use of a reductant or reducing gas. In the case of the plasma mechanism, ore might be more quickly or more extensively reduced or metallized by reducing gas or might be reduced or metallized by otherwise non-reducing gases, such as nitrogen.

An exemplary method may comprise providing solids and a gaseous stream to an inlet of the reduction portion, resulting in ore reduction to reduced metal. The reactions on-going inside reduction section 104 include ore reduction and, within heat tubes 108, combustion or partial oxidation and, outside heat tubes 108, preferred partial oxidation. Reduction of magnetite is shown as an ore reduction example. Combustion, for heat, may be by natural gas as complete oxidation or partial oxidation or it may be by hydrogen. If air is used for combustion, nitrogen and potentially NOx may be present on the product side of the reaction expressions.

For magnetite:

Fe3O4+4H2→3Fe+4H2O Fe3O4+4CO→3Fe+4CO2

Fe3O4+CH4→3Fe+2H2O+CO2

For combustion:

CH4+2O2→CO2+2H2O (natural gas, complete) 2CH4+O2→2CO+4H2 (natural gas, partial) 2H2+O2→2H2O (hydrogen)

Other phases of iron oxide can exist, not shown in the above reactions, such as wüstite or FeO, an intermediate between magnetite and Fe.

In some embodiments, combustion may be by other hydrocarbons, CO, alcohols or heat may be provided electrically, inductively, using microwaves, lasers, generating plasmas or by a combination. Exemplary hydrocarbons include methane, ethane, propane, butane, kerosene, diesel or gasoline. Exemplary alcohols include methanol, ethanol or propanol. Hydrocarbon or alcohol isomers and species with double or triple bonds are included.

Exemplary solids and gaseous species may be provided to the reduction portion 104 at a temperature between 300 °C and 1000 °C, but can be as low as room temperature. In some embodiments, exemplary solids and gaseous species may be provided to the reduction portion 104 at a pressure between 15 psia (or just above local ambient pressure) and 150 psia.

Exemplary gaseous species may be provided to the heat tubes 108 at a temperature between 300 °C and 1000 °C, but can be as low as room temperature. In some embodiments, exemplary gaseous species may be provided to the heat tubes 108 at a pressure between 15 psia (or just above local ambient pressure) and 150 psia.

Partial oxidation may be done inside reduction portion 104 but outside heat tubes 108 while combustion or other heating methods are applied inside heat tubes 108. Partial oxidation generates ore reducing species but creates less heat than combustion, thus requiring significant excess oxidation which generates significant excess reductant, in order to create the heat required for ore reduction, which may be energy-inefficient, although the reactor system 100 can be operated in this manner. Combining partial oxidation with other heating methods, associated with heat tubes 108 and delivery tubes 122, reduces the excess oxidation required while leveraging heating methods which more efficiently create required heat.

The heat transfer mechanisms from delivery tubes extending from plate 122 are identical to or similar with the heat transfer mechanisms from heat tubes 108. Use of heat transfer methods on delivery tubes extending from plate 122 can reduce the heat flux required from heat tubes 108. Heat transfer can also occur to product species, of ore reduction and combustion, which can be conductively and convectively transferred to ore and reductant.

Heat will be leftover in exhaust, by combustion, and will be recovered for pre-heating of ore, reductant and combustion reactants in entrance portion 102 or, in some cases, exit portion 106. The design of such heat exchangers is typical or standard and includes shell and tube configurations. Other configurations are contemplated.

Exemplary methods of heat generation also include electrical power-based methods such as resistive heating, inductive heating, lasers, plasma generation or the application of microwaves. These methods may be on the inside or attached to the outside of heat tubes 108 or delivery tubes 122 and may be combined with combustion (complete oxidation) and with partial oxidation.

In resistive heating, rods, coils, bands or strips can be attached inside or outside the heat tubes 108 or delivery tubes emanating from plate 122 and electrical power applied, as a potential or current, to generate heat by resistance. In some embodiments, specific infra-red wavelengths from the resistively heated materials are significant to heat transfer to ore and reductant.

In inductive heating, rods, coils, bands or strips may be attached inside or outside the heat tubes 108 or delivery tubes emanating from plate 122 and electrical power applied, as a potential or current, to generate electromagnetic fields which couple to ore or reduced metal particles. Coupling results in the induction of vibration in particles which results in their self-heating. Coupling can also be done to heat tubes 108 and delivery tubes emanating from plate 122, resulting in their self-heating and the transfer of heat to ore and reductant by radiation or by conductive contact with gaseous species.

In microwave heating, a magnetron or an assembly of magnetrons may be located inside or outside heat tubes 108 or delivery tubes emanating from plate 122. Specific frequencies are generated with microwave power and direction tuned and targeted to high density ore and reductant sections of reduction portion 104. The frequencies may target any species in such section in a manner that ensures rapid and high heating along with the maximal, optimal or most efficient use of microwaves. Magnetrons might also be located on the top or bottom of plates 122 and 124 to facilitate heating as well.

In laser heating, laser beams directed into the reduction portion 104, notably contacting solid species, result in heat generation by selecting laser wavelengths which result in a surface absorption profile for the material which causes vibration.

In plasma formation, an electric discharge is provided in the reduction portion 104, notably across gaseous species, resulting in plasma formation, plasma collisions and heat generation. A portion of the required reducing gas may be introduced separately into 104 from solids but in proximity to each other in order to facilitate rapid contact with each other and transfer of heat.

Exemplary methods of converting products and exhaust to ore reductants or reducing species involves catalysts which facilitate steam-methane reforming (SMR), dry reforming (DR), water-gas shifting (WGS) and thermo-catalytic decomposition (TD). In the case of water-gas shifting, not only is hydrogen generated but heat is injected into reduction portion 104 since the reaction is exothermic (by about 41 KJ/mol). For reforming and decomposition, required operating temperatures may range from 500-900 °C. For shifting, required operating temperatures may range from 150-500 °C. Any catalyst type and form may be applied, inside or outside heat tubes 108, to effectively generate reductant per specification. At least 5% of the reductant necessary for ore reduction is expected to be generated by this feature.
SMR (steam-methane reforming): CH4+H2O→CO+3H2
DR (carbon dioxide-methane reforming or dry reforming): CH4+CO2→2CO+2H2
WGS (water-gas shifting): CO+H2O→CO2+H2

Electrolysis may use any high temperature tolerant electrolytic devices, which can include reverse operated fuel cells, and is expected to produce at least a 10% reduction in the electric power required to generate reductant necessary for ore reduction (relative to room temperature conditions). The electrolysis stacks are located within reduction portion 104 or even in entrance 102 or exit portion 106, where combustion and ore reduction reaction products CO2 and H2O are present and high temperatures ranging from 300-1200 °C exist. Noted products transport into or through the electrolysis cell where generated reductant can be deployed directly into reduction portion 104 for ore reduction or be transported for use where desired in reactor system 100.

Electrolysis of water vapor:
Cathode: 2H2O(g)+4e−→2H2(g)+2O2− Anode: 2O2−→O2(g)+4e−
Overall: 2H2O(g)→2H2(g)+O2(g)

Electrolysis of carbon dioxide:
Cathode: 2CO2(g)+4e−→2CO(g)+2O2− Anode: 2O2−→O2(g)+4e−
Overall: 2CO2(g)→2CO(g)+O2(g)

Oxygen can be used for combustion or partial oxidation.

Exemplary configurations and applications of heat tubes 108, inside which combustion may occur, provide a separation between ore as well as gaseous reductant and reduction products relative to gaseous combustion products. Also, if heat tubes 108 utilize electrical power-based heating methods then there are no gaseous species involved in heating. The separation allows independent operation of the heat delivery method relative to the feed rates relevant to ore reduction. As a result, higher feed rates can be delivered to reactor system 100, with the goal of increasing the reduced metal production rate, which may rely on maximizing or optimizing fluid dynamic, heat transfer and mass transfer phenomena within reduction portion 104, without needing to address the impact of combustion exhaust. Simultaneously, heat generation can be increased to achieve reduction portion 104 requirements without needing to address the impact of ore and reductant feed rates on heat transfer capability, thermal profiles and thermal gradient formation.

Heat tubes 108 may be joined to plates 122 and 124 such that they may be easily removed and replaced. This is done by coupling heat tubes 108 with fittings that can be rapidly connected and disconnected and the heat tubes 108 removed through their individual ports in plates 122 or 124. Additionally, any features attached to the outside of the heat tubes 108 may be rapidly replaced or modified. These features make the system easy to scale or modify in-place.

Delivery tubes may be joined at plate 122 or plate 124 such that they may be easily removed and replaced.

The application of heat tubes 108 allows the ore reduction reactor system 100 to be designed and operated such that the externally supplied energy input for the generation of reductant or for the transport of heat can be, separately or combined, decreased by at least 10%. The use of delivery tubes along with heating features, emanating from plate 122 (and potentially plate 124), along with heat tubes 108, may provide additional decreases in operating energy requirement. This improvement in energy-efficiency not only decreases operating cost and process footprint but results in a decrease in the generation and emission of greenhouse gases, notably, carbon dioxide by at least 10%.

In addition, the application of heat tubes 108 and also heating feature incorporated delivery tubes emanating from 122 (and potentially plate 124) allows for the use of any combustible species or heating method to deliver heat into reduction portion 104. Such options can result in no greenhouse gas generation and emission as the sources may include electrical power from non-hydrocarbon methods or hydrogen as a combustible, acquired from water.

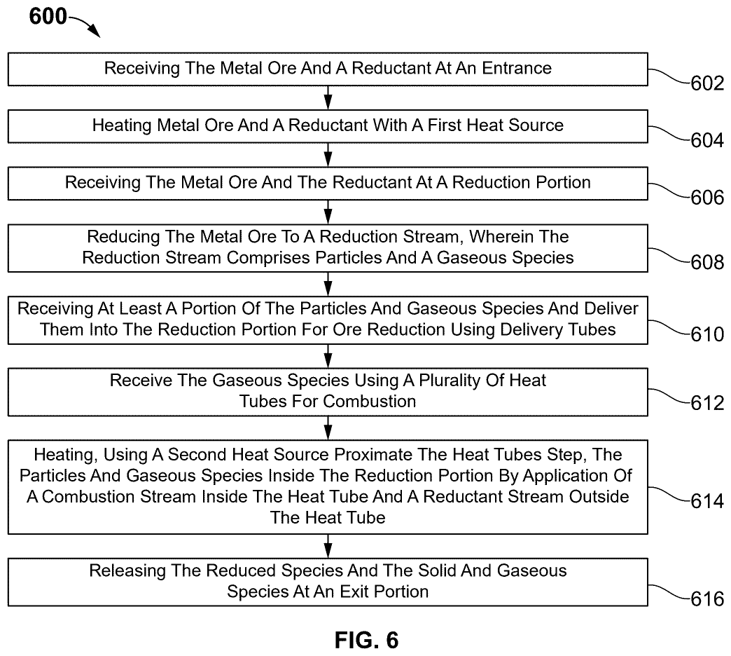

With reference now to FIG. 6 a step-wise flow chart for a method for delivering and controlling heat to metal ore as a process feature in reducing the metal ore. The method comprises receiving the metal ore and a reductant at an entrance, step 602, heating metal ore and a reductant with a first heat source, step 604, receiving the metal ore and the reductant at a reduction portion, step 606, reducing the metal ore to a reduction stream, wherein the reduction stream comprises particles and a gaseous species step 608, receiving at least a portion of the particles and gaseous species and delivering them into the reduction portion for ore reduction using delivery tubes step 610, receiving the gaseous species using a plurality of heat tubes for combustion step 612, heating, using a second heat source proximate the heat tubes, the particles and gaseous species inside the reduction portion by application of a combustion stream inside the heat tube and a reductant stream outside the heat tube step 614 and releasing the reduced species and the solid and gaseous species at an exit portion step 616.

1. A system for reduction of metal ore, the system comprising:
an entrance portion configured to receive the metal ore and a reductant, wherein the metal ore and a reductant is heated with a first heat source;
a reduction portion in fluid communication with the entrance portion, wherein the reduction portion is configured to receive the metal ore and the reductant, wherein the reduction portion is configured to reduce the metal ore to a reduction stream, wherein the reduction stream comprises particles and a gaseous species, and wherein the reduction portion comprises:
a plurality of delivery tubes that extend into the reduction portion and are configured to receive at least a portion of the particles and gaseous species and deliver them into the reduction portion for ore reduction;
a plurality of heat tubes configured to receive gaseous species for combustion;
a second heat source proximate the heat tubes, wherein the second heat source is configured to further heat the particles and gaseous species inside the reduction portion by application of a combustion stream inside the heat tube and a reductant stream outside the heat tube;
a top plate coupled to the heat tubes at a top end;
a bottom plate coupled to the heat tubes at a bottom end;
wherein each of the top and bottom plates comprise:
a first plurality of channels that supply the particles and gaseous species into the heat tube for ore reduction;
a second plurality of channels that supply gaseous species into the heat tube for combustion, a plurality of channels that supply gaseous species outside of the heat tube for combustion in the form of partial oxidation;
a third plurality of channels that supply the particles and gaseous species outside of the heat tube for ore reduction; and
an exit portion coupled to the reduction portion, wherein the exit portion is configured to release the reduced species and the solid and gaseous species.

2. The system of claim 1, wherein the heat tubes are further configured to contain combustion and to generate additional reductant.

3. The system of claim 1, wherein the second heat source comprises an electrical-based heat source, a resistive heat source, a microwave heat source, a laser-based heat source, a plasma-forming heat source or inductive based heat source or any combination thereof.

4. The system of claim 1, wherein the gaseous species comprise reductant gas.

5. The system of claim 1, wherein the delivery tubes comprise an additional heat source wherein the delivery tube is further configured to deliver reductant to the reduction portion.

6. The system of claim 3, wherein the second heat source is positioned in an interior of the heat tube.

7. The system of claim 3, wherein the second heat source is positioned on the exterior of the heat tube.

8. (canceled)

9. The system of claim 1, further comprising a catalyst located in an interior, exterior, or both, of the heat tubes.

10. The system of claim 1, further comprising a catalytic bed located in an interior, exterior, or both of the heat tubes to generate additional reductants using gaseous species and reduction products.

11. The system of claim 1, wherein at least one of an electrical-based heat devices comprises an electrolytic cell, wherein the electrolytic cell is configured to generate additional reductants using gaseous species and reduction products.

12. (canceled)

13. (canceled)

14. (canceled)

15. (canceled)

16. (canceled)

17. (canceled)

18. (canceled)

19. (canceled)

20. (canceled)
